(19) United States
(12) Patent Application Publication
(10) Pub. No.: US 2026/0070796 A1
(43) Pub. Date: Mar. 12, 2026

(54) METHOD OF MANUFACTURING INORGANIC OXIDE NANOFIBER, AND NANOSTRUCTURE

(71) Applicant: Sony Group Corporation, Tokyo (JP)

(72) Inventor: Shigeru SAKAMOTO, Tokyo (JP)

(21) Appl. No.: 19/108,557

(22) PCT Filed: Oct. 6, 2023
(86) PCT No.: PCT/JP2023/036626

§ 371 Date: Mar. 4, 2025

(30) Foreign Application Priority Data
Oct. 17, 2022 (JP) 2022-166390

(51) Int. Cl. C01B 33/193; B82Y 30/00; B82Y 40/00; C03B 37/01; C09C 1/30

(52) U.S. Cl. CPC C01B 33/193; C03B 37/011; C09C 1/3063; B82Y 30/00; B82Y 40/00; C01P 2004/16

(57) ABSTRACT

A method of manufacturing an inorganic oxide nanofiber of an embodiment of the disclosure includes: preparing a mixture solution by dissolving water, a metal alkoxide, a catalyst, and a surfactant in an aprotic or protic polar solvent; removing the polar solvent from the mixture solution and synthesizing a nanostructure having a reverse two-dimensional hexagonal structure; and thereafter decomposing the nanostructure.

### TECHNICAL FIELD

The present disclosure relates to a method of manufacturing an inorganic oxide nanofiber, and to a nanostructure as a precursor thereof.

### BACKGROUND ART

As a method of manufacturing a nanofiber, there are disclosed, for example, an electrospinning method (NPTL 1) in which a precursor solution is extruded from a minute hole and solidified, a molecular template method (NPTL 2) in which a fibrous organic molecule such as amyloid is fabricated as a template, and a microphase separation method (NPTL 3) in which a microphase separation structure of a block copolymer is fabricated as a template.

### CITATION LIST

### Non-Patent Literatures

NPTL 1: Angewandte Chemie International Edition 2007, 46, 5670.

NPTL 2: Small 2018, 14, 1802854.

NPTL 3: Advanced Materials 1999, 11, 141.

### SUMMARY OF THE INVENTION

Incidentally, high transparency and flexibility have been desired for a nanofiber in order to expand applications.

It is desirable to provide a method of manufacturing an inorganic oxide nanofiber having high transparency and flexibility, and a nanostructure having high transparency and flexibility.

A method of manufacturing an inorganic oxide according to an embodiment of the present disclosure includes: preparing a mixture solution by dissolving water, a metal alkoxide, a catalyst, and a surfactant in an aprotic or protic polar solvent; removing the polar solvent from the mixture solution and synthesizing a nanostructure having a reverse two-dimensional hexagonal structure; and thereafter decomposing the nanostructure.

A nanostructure according to an embodiment of the present disclosure includes: a plurality of nanofibers each including an inorganic oxide; and a plurality of surfactants having a hydrophilic group and a hydrophobic group, the hydrophilic group being adsorbed to a surface of each of the plurality of nanofibers by an electrostatic interaction. The nanostructure has a reverse two-dimensional hexagonal structure in which the plurality of nanofibers is periodically arranged.

In the method of manufacturing the inorganic oxide according to the embodiment of the present disclosure and the nanostructure according to the embodiment of the present disclosure, the mixture solution is prepared by dissolving the water, the metal alkoxide, the catalyst, and the surfactant in the aprotic or protic polar solvent, and the polar solvent is removed from the mixture solution. This makes it possible to form the nanostructure having the reverse two-dimensional hexagonal structure in which the plurality of nanofibers each including the inorganic oxide is periodically arranged. The hydrophilic group of the surfactant is adsorbed to the surface of each of the plurality of nanofibers by the electrostatic interaction. Thereafter, the nanostructure is decomposed to thereby obtain the inorganic oxide nanofiber having a diameter smaller than a diameter of a nanofiber obtained with a general manufacturing method.

### BRIEF DESCRIPTION OF DRAWINGS

FIG. 1 is a perspective diagram schematically illustrating a nanostructure according to an embodiment of the present disclosure.

FIG. 2 is an enlarged schematic diagram illustrating an example of a cross section of a portion of the nanostructure illustrated in FIG. 1.

FIG. 3 is a conceptual diagram of nanofibers of the present embodiment upon being photographed using a transmission electron microscope.

FIG. 4 is a flowchart illustrating steps of manufacturing a nanofiber according to an embodiment of the present disclosure.

FIG. 5 is a schematic diagram illustrating steps of decomposing a nanostructure illustrated in FIG. 4.

FIG. 6 is an X-ray diffraction pattern of a structure obtained in Experiment example 1.

### MODES FOR CARRYING OUT THE INVENTION

In the following, description is given in detail of embodiments of the present technology with reference to the drawings. The following description is merely a specific example of the present disclosure, and the present disclosure should not be limited to the following aspects. Moreover, the present disclosure is not limited to arrangements, dimensions, dimensional ratios, and the like of each component illustrated in the drawings. It is to be noted that the description is given in the following order.
1. Embodiment (An example of a nanostructure having a reverse two-dimensional hexagonal structure and an example of a method of manufacturing an inorganic oxide nanofiber)
1-1. Configuration of Nanostructure and Configuration of Nanofiber
1-2. Method of Manufacturing Nanofiber
1-3. Workings and Effects
2. Examples
3. Use Examples of Nanofiber

### 1. EMBODIMENT

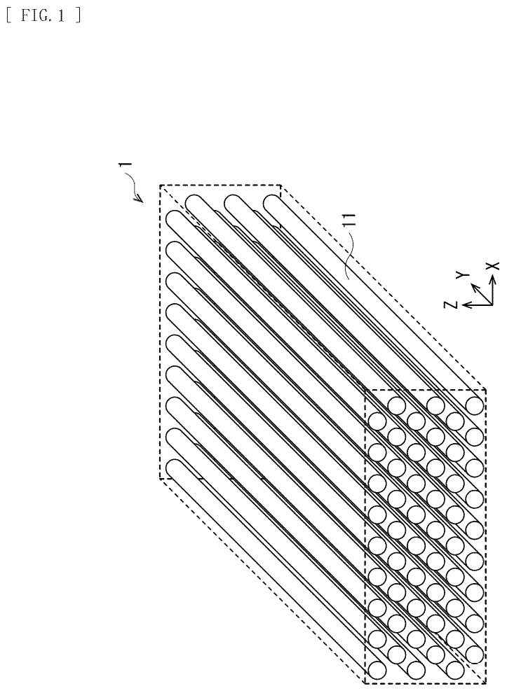

FIG. 1 schematically illustrates an example of a configuration of a nanostructure (a nanostructure 1) according to an embodiment of the present disclosure. The nanostructure 1 is a lyotropic liquid crystal in which a plurality of nanofibers (a plurality of nanofibers 11) is periodically arranged, and the nanofiber 11 obtained by decomposing the nanostructure 1 is used, for example, in a reinforced plastic, an anti-reflection film, a heat insulating material, a semiconductor material, an additive, a catalyst, or the like.

### 1-1. Configuration of Nanostructure and Configuration of Nanofiber

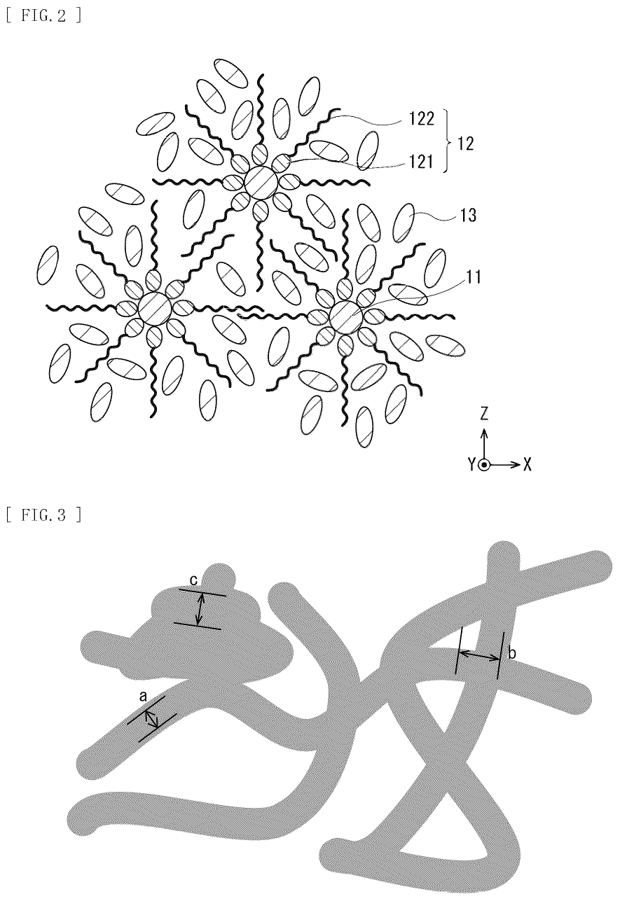

FIG. 2 schematically illustrates, in an enlarged manner, an example of a cross section of a portion of the nanostructure 1 illustrated in FIG. 1. The nanostructure 1 of the present embodiment is, for example, a lyotropic liquid crystal in which the plurality of nanofibers 11 extending in a Y-axis direction is periodically arranged in an X-axis direction and a Z-axis direction. The plurality of nanofibers 11 includes a hydrophilic inorganic oxide, and a plurality of surfactants 12 is adsorbed to a surface of each of the plurality of nanofibers 11. The surfactant 12 includes a hydrophilic group 121 and a hydrophobic group 122, and the hydrophilic group 121 is adsorbed to the surface of the nanofiber 11 by an electrostatic interaction. The hydrophobic groups 122 of the respective plurality of surfactants 12 adsorbed to the plurality of nanofibers 11 assemble with each other by the electrostatic interaction, thereby causing the plurality of nanofibers 11 to be periodically arranged to form the nanostructure 1. That is, the nanostructure 1 has a reverse two-dimensional hexagonal structure.

The nanofiber 11 is, for example, a fibrous material having a diameter less than or equal to 100 nm and a length greater than or equal to 100 times the diameter. The nanofiber 11 is configured by a combination of metal atoms of a single kind or a plurality of kinds, and includes the hydrophilic inorganic oxide. In the nanofiber 11, for example, metal atoms (M) and oxygen atoms (O) three-dimensionally form a covalent bond network via M-O-M bonding. The metal atom (M) is, for example, a silicon atom (Si), and the nanofiber 11 is, for example, a silica nanofiber.

An average diameter (φ) of the nanofibers 11 is preferably, for example, less than or equal to 10 nm. A thickness of the nanofiber 11 affects transparency and flexibility of the reinforced plastic, the anti-reflection film, and the heat insulating material each of which is formed using the nanofiber 11, and performances as porous materials of the semiconductor material, the additive, and the catalyst each of which is also formed using the nanofiber 11. For example, the thinner the nanofiber 11, the larger a surface area and the smaller a pore size of the porous material formed by using the nanofiber 11. The thinner the nanofiber 11, the better the transparency owing to a reduction in optical scattering. The thinner the nanofiber 11, the better the flexibility of the structure formed using the nanofiber 11.

The average diameter (φ) of the nanofibers 11 is determined as follows.

First, the nanofibers 11 to be measured are dispersed in an appropriate organic solvent, and the dispersion liquid is dropped onto a material-grid for transmission electron microscope (TEM) observation and air-dried to thereby fabricate a sample. A transmission electron microscope (Tecnai G2 manufactured by FEI) is used to capture a TEM photograph of the obtained sample in such a manner that it is possible to observe the multiple nanofibers 11 at an acceleration voltage of 200 kV and in a field of view of 50 nm×50 nm. It is to be noted that a photographing position is selected at random on the sample.

Next, 50 nanofibers 11, of which diameters can be clearly confirmed in a direction of an observation plane, are selected from the captured TEM photograph. When the number of the nanofibers 11, of which the diameters can be clearly confirmed, present inside photographed one field of view is less than 50, 50 nanofibers 11, of which the diameters can be clearly confirmed in the direction of the observation plane, are selected from a plurality of fields of view.

FIG. 3 is a conceptual diagram of a TEM photograph in a case where a transmission electron microscope is used to capture an image of the nanofibers 11. In FIG. 3, for example, any location “a”, for which it is possible to clearly confirm its diameter, is selected. Meanwhile, for example, as for a location “b” and a location “c”, the nanofibers 11 overlap each other and shapes thereof are not confirmable, and thus the location “b” and the location “c” are not suitable as measurement targets. A maximum diameter of each of the selected 50 nanofibers 11 is measured at an intermediate portion of each of the nanofibers 11.

When measuring the diameter, it is substantially difficult to observe the surfactant adsorbed to the surface of the nanofiber 11 or a modified functional group, and the diameter of a portion of the fiber part excluding those is measured. By determining a median of the 50 diameters determined in this manner, the average diameter of the nanofibers 11 is obtained. It is to be noted that, in a case where a branch portion is present in the middle, it is measured as a single nanofiber up to the branch portion, and the nanofiber branched from the branch portion is measured as a separate nanofiber.

The surfactant 12 includes amphiphilic molecules each having the hydrophilic group 121 and the hydrophobic group 122. The hydrophilic group 121 is adsorbed to the surface of the nanofiber 11 having the hydrophilic property by the electrostatic interaction. This prevents the plurality of nanofibers 11 from being coupled to each other. The hydrophobic groups 122 of the respective plurality of surfactants 12 adsorbed to the plurality of nanofibers 11 assemble with each other by the electrostatic interaction, thereby causing the plurality of nanofibers 11 to be periodically arranged to form an aggregate (the nanostructure 1) of the plurality of nanofibers 11.

As the surfactant 12, those containing 1 to 3 alkyl chains may be used. Specifically, examples thereof include a quaternary ammonium salt, an alkyl polyether, and an alkyl sulfuric acid salt. A length of the hydrophobic group 122 preferably has a length that exhibits sufficient electrostatic interaction to cause self-assembly. Specific examples of the hydrophobic group 122 include a hexyl group, an octyl group, a decyl group, a dodecyl group, a tetradecyl group, a hexadecyl group, an octadecyl group, and derivatives thereof.

The nanostructure 1 may include, for example, a hydrophobic additive 13 between the periodically arranged plurality of nanofibers 11, specifically between the plurality of hydrophobic groups 122 that is positioned on an outer side of the plurality of nanofibers 11. The hydrophobic additive 13 increases a volume ratio of a hydrophobic part to a hydrophilic part, thereby making it easier to form the reverse two-dimensional hexagonal structure. Examples of the hydrophobic additive 13 include an alkane, an alcohol, and an aromatic compound. Specific examples thereof include an alcohol having 6 to 20 carbon atoms, an alkane having 6 to 20 carbon atoms, 1,3,5-trimethylbenzene, 1,3,5-triethylbenzene, and 1,3,5-tripropylbenzene.

### 1-2. Method of Manufacturing Nanofiber

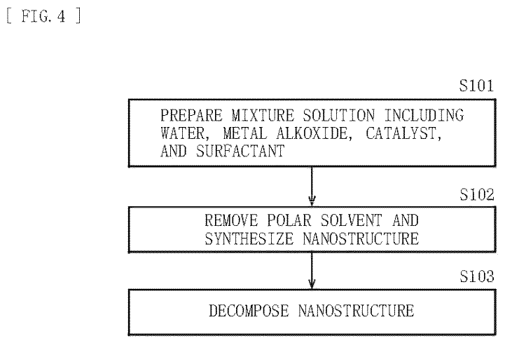

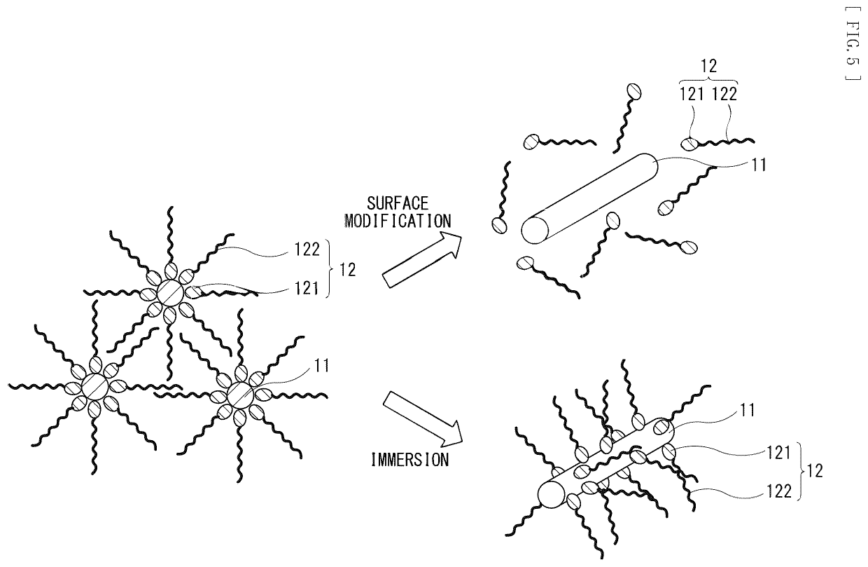

FIG. 4 illustrates a flow of steps of manufacturing the nanofiber 11.

First, water (e.g., pure water or deionized water), a metal alkoxide, a catalyst, and a surfactant, and an aprotic or protic polar solvent capable of completely dissolving the above substances are put into a beaker, and a mixture solution is stirred at room temperature to sufficiently hydrolyze the metal alkoxide (step S101).

The metal alkoxide does not interfere with formation of a metal oxide skeleton even when the metal alkoxide includes molecules in which one or more the alkoxy groups are substituted with one or more non-hydrolysis functional groups. As the metal alkoxide, a compound represented by the following general formula (1) is usable.

(Chemical Formula 1)

R¹_{X}M(OR²)₄₋ₓ . (1)
(R¹ is any of a methyl group, an ethyl group, a propyl group, an isopropyl group, a butyl group, a pentyl group, a hexyl group, a heptyl group, an octyl group, a decyl group, a dodecyl group, a hexadecyl group, a vinyl group, and a phenyl group. R² is any of a methyl group, an ethyl group, a propyl group, and an isopropyl group. M is any of silicon (Si), aluminum (Al), titanium (Ti), tin (Sn), and zinc (Zn). X is an integer of 0 or 2 or less.)

As the catalyst, for example, an acid catalyst such as acetic acid, hydrochloric acid, nitric acid, or a sulfuric acid is usable.

Examples of the protic polar solvent include methanol, ethanol, isopropanol, butanol, acetic acid, and formic acid. Examples of the aprotic polar solvent include N-methylpyrrolidone, dichloromethane, tetrahydrofuran, acetic acid ethyl, acetone, dimethylformamide (DMF), acetonitrile, and dimethyl sulfoxide (DMSO).

A hydrophobic additive may be further added to the mixture solution. Examples of the hydrophobic additive include an alcohol represented by the following general formula (2), an alkane represented by the following general formula (3), 1,3,5-trimethylbenzene, 1,3,5-triethylbenzene, and 1,3,5-tripropylbenzene.

(Chemical Formula 2)

CₙH₂ₙ₊₁OH. (2)

(Chemical Formula 3)

CₙH₂ₙ₊₂. (3)
(n is an integer of 6 or more and 20 or less.) It is to be noted that in step S101, the water, the metal alkoxide, and the catalyst may be mixed and reacted with each other, following which the surfactant and the aprotic or protic polar solvent may be added. A reaction product of the water, the metal alkoxide, and the catalyst is a hydrophilic inorganic oxide precursor.

Next, the mixture solution is spread on a substrate such as a glass substrate or a silicon substrate, or a container such as a stainless steel bat or a petri dish to remove the polar solvent. Removing (volatilization) of the polar solvent simultaneously induces formation and self-assembly of the inorganic oxide and causes the nanostructure 1 to be formed (step S102). Specifically, the inorganic oxide precursor is polymerized to form the plurality of nanofibers 11, and the hydrophilic group 121 of the surfactant 12 is adsorbed to the surface of each of the plurality of nanofibers by the electrostatic interaction by the electrostatic interaction. Further, the hydrophobic groups 122 of the respective plurality of surfactants 12 adsorbed to the plurality of nanofibers assemble with each other by the electrostatic interaction. As a result, the nanostructure 1 in which the plurality of nanofibers 11 are periodically arranged is obtained.

The polar solvent may be volatilized, for example, by air-dry. Alternatively, the polar solvent may be volatilized, for example, by transferring the mixture solution to a closed vessel and subjecting the polar solvent to depressurization with a vacuum-pump or the like.

Thereafter, the nanostructure 1 is decomposed to obtain the plurality of nanofibers 11 (step S103). As the decomposition of the nanostructure 1, for example, two methods illustrated in FIG. 5 may be used.

### Nanostructure Decomposition Method 1

It is possible to decompose the nanostructure 1 by, for example, surface modification with use of an organic silane molecule. In the nanostructure 1, each of the plurality of nanofibers 11 is coated by the surfactants 12, and the structure is maintained by interaction between the surfactants 12. By covalently bonding the organic silane molecule to the surface of each of the nanofibers 11, as illustrated in FIG. 5, the surfactant 12 is detached and the nanostructure 1 is decomposed.

First, the nanostructure 1 is dispersed into a predetermined organic solvent. Thereafter, an organic silane compound having a reactive functional group represented by the following general formula (4) or the following general formula (5), or an organic silane compound not having a reactive functional group represented by the following general formula (6) or the following general formula (7) is added to the organic solvent, and the organic solvent is heated as needed.

(Chemical Formula 4)

R³_{Y}Si(OR⁴)_{4-Y}. (4)

(Chemical Formula 5)

R³_{Y}SiCl_{4-Y}. (5)
(R³ is any of a hydrogen atom, a vinyl group, an acryloxy group, a methacryloxy group, an aminopropyl group, a glycidoxypropyl group, and a mercaptopropyl group. R⁴ is any of a methyl group, an ethyl group, a propyl group, and an isopropyl group. Y is an integer of 3 or less.)

(Chemical Formula 6)

R⁵_{Z}Si(OR⁶)_{4-Z}. (6)

(Chemical Formula 7)

R⁵_{Z}SiCl_{4-Z}. (7)
(R⁵ is any of a methyl group, an ethyl group, a propyl group, an isopropyl group, a butyl group, a pentyl group, a hexyl group, a heptyl group, an octyl group, a decyl group, a dodecyl group, a hexadecyl group, a vinyl group, and a phenyl group. R⁶ is any of a methyl group, an ethyl group, a propyl group, and an isopropyl group. Z is an integer of 3 or less.) Thereafter, the excess organic silane compound and the detached surfactant 12 are removed by distillation or liquid-liquid phase separation, which makes it possible to isolate the nanofiber 11. The thus obtained nanofiber 11 has a surface modified by the organic silane molecule derived from the organic silane compound.

### Nanostructure Decomposition Method 2

It is possible to decompose the nanostructure 1 by, for example, immersing the the nanostructure 1 in an appropriate organic solvent. For example, as illustrated in FIG. 5, immersing the nanostructure 1 in the organic solvent eliminates the interaction between the surfactants 12 adsorbed to the surfaces of the respective nanofibers 11, and makes it possible to isolate the nanofibers 11. The thus obtained nanofiber 11 has a surface to which the plurality of surfactants 12 are adsorbed.

### 1-3. Workings and Effects

In the method of manufacturing the nanofiber 11 according to the present embodiment, the mixture solution is prepared by dissolving the water, the metal alkoxide, the catalyst, and the surfactant in the aprotic or protic polar solvent, and the polar solvent is removed from the mixture solution. This makes it possible to form the nanostructure 1 having the reverse two-dimensional hexagonal structure in which the plurality of nanofibers 11 each including the inorganic oxide is periodically arranged. The hydrophilic group 121 is adsorbed to the surface of each of the plurality of nanofibers 11 by the electrostatic interaction. Thereafter, the nanostructure 1 is decomposed to thereby obtain the nanofiber 11 having a diameter smaller than a diameter of a nanofiber obtained with a general manufacturing method. This will be described below.

A nanofiber is used in various fields, for example, in a reinforced plastic, an anti-reflection film, a heat insulating material, a semiconductor material, an additive, a catalyst, or the like. In particular, a nanofiber including an inorganic oxide has been developed owing to its high weather resistance, stability, and mechanical strength.

Incidentally, as described above, the thickness of the nanofiber affects the transparency, the flexibility, and the performance as a porous material of the reinforced plastic, the anti-reflection film, the heat insulating material, the semiconductor material, the additive, and the catalyst each of which is formed using the nanofiber. For example, in the nanofiber having an average diameter (φ) of less than or equal to 10 nm, the performance of the porous material such as the catalyst is expected to be improved owing to an increase in surface area and a reduction in pore size, and the transparency is expected to be improved and the flexibility is expected to be improved owing to a reduction in optical scattering.

However, in the electrospinning method, the molecular template method, and the microphase separation method described above, it is theoretically difficult to manufacture a nanofiber having the average diameter (φ) of less than or equal to 10 nm.

In addition, for a nanostructure having a two-dimensional hexagonal structure in which an orientation is so controlled as to have a hydrophobic part in a central portion and a hydrophilic part in an outer portion, the following method, for example, has been developed. A mesoporous substance having pores in a honeycomb shape is formed by removing an organic portion by firing or acid treatment, and a nanofiber is formed using the pores as a template. However, it has been found that it is difficult to obtain the inorganic oxide nanofiber of less than or equal to 10 nm by any of the methods, because growth of an inorganic oxide is generally isotropic, and there is no suitable template for promoting anisotropic uniaxial growth.

In contrast, in the present embodiment, the nanostructure 1 having the reverse two-dimensional hexagonal structure in which the plurality of nanofibers is periodically arranged is formed. The hydrophilic group 121 of each of the plurality of surfactant 12 is adsorbed to the surface of each of the plurality of nanofibers 11. The nanostructure 1 is decomposed to thereby obtain the nanofiber 11. In the nanostructure 1 having the reverse two-dimensional hexagonal structure, the hydrophobic groups 122 of the respective plurality of surfactants 12 adsorbed to the plurality of nanofibers 11 assemble with each other by the electrostatic interaction to thereby form a structure. Therefore, for example, the nanostructure 1 is decomposed into the plurality of nanofibers 11 by, for example, surface modification with use of the organic silane molecule or immersion in the organic solvent. Thus, for example, the nanofiber 11 having an average diameter (φ) of less than or equal to 10 nm is obtained.

As described above, by using the method of manufacturing the nanofiber 11 of the present embodiment, it is possible to obtain the nanofiber 11 having high transparency and flexibility.

### 2. EXAMPLES

Next, Examples of the present disclosure will be described.

### Experiment Example 1

First, water, tetraethoxysilane as the metal alkoxide, hydrochloric acid as the catalyst, dihexadecyl dimethylammonium bromide as the surfactant, 1-decanol as the hydrophobic additive, and ethanol (the polar solvent) as the solvent were put into a beaker, and the mixture was stirred at room temperature to thereby hydrolyze the metal alkoxide. Thereafter, the resultant was spread in a container and the polar solvent was removed to thereby obtain a structure. A mixture ratio (a molar ratio) between the water, the metal alkoxide, the catalyst, the surfactant, the hydrophobic additive, and the solvent was set to 3.2:1.0:0.0058:0.4:0.8:10.

### Experiment Example 2

A structure was obtained using a method similar to that in Experiment example except that hexane (a non-polar solvent) was used as the solvent.

### Evaluation of Structure

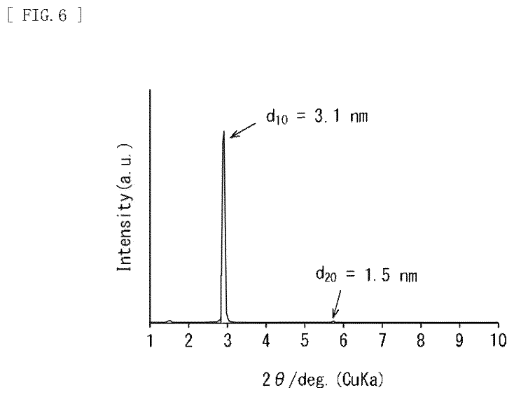

An X-ray diffractometer (Rigaku RINT-Ultima III parallel beam diffractometer) was used to acquire an X-ray diffraction pattern of the structure obtained in each of Experiment examples 1 and 2 using CuKα radiation (λ=0.154 nm, 40 kV, 30 mA) as an X-ray source. FIG. 6 is the X-ray diffraction pattern of the structure obtained in Experiment example 1. In Experiment example 1, a peak representing the hexagonal structure was confirmed, whereas no peak was confirmed in Experiment example 2.

In addition, the structure obtained in Experiment example 1 was dissolved in tetrahydrofuran (THF), and the resultant was dropped on a Cu grid for observation, air-dried and observed under a condition of 3 kV and 5.5 mA using a scanning electron microscope (HITACHI S-5500 microscope). As a result, it was confirmed that resultant was a nanofiber having a fiber diameter of 2 nm to 3 nm.

### 3. USE EXAMPLES OF NANOFIBER

The nanofiber 11 including the inorganic oxide according to the above-described embodiment and the structure formed by using the same each have weather resistance in which it is difficult to be degraded even when exposed to UV light or oxygen for a long period of time. In addition, the nanofiber 11 including the inorganic oxide according to the above-described embodiment and the structure formed by using the same are each stable with little change in dimension and physical properties with respect to temperature and humidity. Further, the nanofiber 11 including the inorganic oxide according to the above-described embodiment and the structure formed by using the same each have a high mechanical strength against an external stress such as a tensile stress or a bending stress. Further, the structure formed by using the nanofiber 11 including the inorganic oxide according to the above-described embodiment has a space between fibers to thereby become a porous material.

Furthermore, the surface of the nanofiber 11 is coated by the surfactant 12 or the organic silane molecule, and thus, the plurality of nanofibers 11 is in a state of not being able to be covalently bonded to each other. As a result, aggregation of the plurality of nanofibers 11 is prevented. In addition, the plurality of nanofibers 11 may be coupled to each other via a cross-linking part including, for example, an organic material or an inorganic material containing a silyl group to form a structure. As a result, a gap is formed between the coupled plurality of nanofibers 11, which makes it possible to form a heat insulating material having a high light transmittance.

Furthermore, the nanofibers 11 may be coupled to each other via a cross-linking part including an inorganic oxide to form a structure. This makes it possible to provide a heat insulating material having high stability against ultraviolet rays.

In addition, the surface of the nanofiber 11 may be coated by an organic silane molecule having an organic functional group or a fluoro group, or an organic silane molecule having an organic functional group or a fluoro group and further having a reactive functional group, and the nanofibers 11 may be coupled to each other via a cross-linking part to form a structure. This makes it possible to configure, for example, a porous film having a high light transmittance and high water repellency while preventing aggregation of the plurality of nanofibers 11 with each other and suppressing growth of the fiber diameter.

That is, it is possible to use each of the nanofiber 11 and the structure formed using the same, for example, as a reinforced plastic, an anti-reflection film attached to a television, a lens, a window, and the like, a building material, an electric appliance, a heat insulating material used in a bathtub, and the like. In addition, it is possible to use each of the nanofiber 11 and the structure formed using the same as a semiconductor material. It is also possible to use each of the nanofiber 11 and the structure formed using the same as: an additive having, for example, hygroscopic and deodorizing functions, for clothing, an electric appliance, a filter, and the like; or a catalyst for a chemical product, a filter, and the like.

Specifically, when each of the nanofiber 11 and the structure formed using the same has a light transmittance of 70% or higher, for example, it is possible to use each of them for window glass of automobiles, or the like. Furthermore, when each of the nanofiber 11 and the structure formed using the same has a light transmittance of 90% or higher, for example, it is possible to use each of them as window glass of buildings, glass substrates, and alternative materials to plastic materials, for example.

Furthermore, in the nanofiber 11 according to the above-described embodiment, a silica source derived from rock may be used as a raw material. That is, according to the present technology, it is possible to provide a plastic alternative material produced from a rock-derived inorganic oxide as a main raw material. With such a plastic alternative material, in which a plastic content is smaller than that of an existing nanocomposite material or a plastic material and the main raw material has biocompatibility and hydrolyzability, there is a lower risk of becoming floating garbage that is harmful to living bodies even when the plastic alternative material flows into the sea. Further, with such a plastic alternative material, in which a main component produced when burnt is water vapor, it is possible to reduce an amount of greenhouse effect gases to be discharged.

Further, each of the nanofiber 11 and the structure formed using the same has light transmissivity, and thus, it is possible to attach each of them to a glass window of houses, offices, or the like, to place each of them between glasses of a double-glazed window, or to use each of them as a heat insulating material for a refrigerator, a bathtub, or the like, or as a transmissive member of, for example, a solar collector. For example, by applying each of the nanofiber 11 and the structure formed using the same to the glass window or the like, a higher heat insulating effect than that of a window including a a common glass material can be expected, and the heat insulating effect makes it possible to reduce energy consumed by cooling and heating equipment. Each of the nanofiber 11 and the structure formed using the same may also be applied to a transparent plate of a solar collector, and the heat insulating effect makes it possible to improve heat collecting efficiency of the solar collector.

In addition, employing the nanofiber 11 and the structure formed using the same allows for applications similar to those of typical porous materials, for example: an adsorbent of an odorous component, bacteria, and virus; a hygroscopic material that controls air humidity to be constant; and sound-absorbing material that prevents a sound wave from traveling. In addition, the nanofiber 11 and the structure formed using the same are each able to be used for an application requiring transparency, and thus are each also applicable to a photocatalyst, artificial photosynthesis, a structural material for an electronic apparatus such as a solar cell or a semiconductor, as well as to a low dielectric constant film, or the like.

Further, the nanofiber 11 may be mixed with a resin material to thereby be used as a nanocomposite material to be used in tires, airplanes, paints, and the like, for example.

In addition, the nanofiber 11 may be dry spun to thereby be used as a fiber used for clothes, seats, and the like, for example.

Although the present disclosure has been described with reference to the embodiment, Examples, and the use examples, the present disclosure is not limited to the embodiment and the use examples described above, but may be modified in a wide variety of ways.

It is to be noted that the effects described herein are merely exemplary and should not be limited thereto, and may further include other effects.

It is to be noted that the present technology may also have the following configurations. According to the present technology having the following configuration, it is possible to obtain an inorganic oxide nanofiber having high transparency and flexibility.
(1)

A method of manufacturing an inorganic oxide nanofiber, the method including:
preparing a mixture solution by dissolving water, a metal alkoxide, a catalyst, and a surfactant in an aprotic or protic polar solvent;
removing the polar solvent from the mixture solution and synthesizing a nanostructure having a reverse two-dimensional hexagonal structure; and
thereafter decomposing the nanostructure.
(2)

The method of manufacturing the inorganic oxide nanofiber according to (1), in which an acid catalyst is used as the catalyst.
(3)

The method of manufacturing the inorganic oxide nanofiber according to (2), in which the acid catalyst includes any of acetic acid, hydrochloric acid, nitric acid, and sulfuric acid.
(4) The method of manufacturing the inorganic oxide nanofiber according to any one of (1) to (3), in which a hydrophobic additive is further added to the mixture solution.
(5)

The method of manufacturing the inorganic oxide nanofiber according to (4), in which used as the hydrophobic additive is at least one of an alcohol having 6 to 20 carbon atoms, an alkane having 6 to 20 carbon atoms, 1,3,5-trimethylbenzene, 1,3,5-triethylbenzene, or 1,3,5-tripropylbenzene.
(6)

The method of manufacturing the inorganic oxide nanofiber according to any one of (1) to (5), in which the polar solvent is removed by air-drying the mixture solution.
(7)

The method of manufacturing the inorganic oxide nanofiber according to any one of (1) to (6), in which the polar solvent is removed by being subjected to depressurization in a closed vessel.
(8)

The method of manufacturing the inorganic oxide nanofiber according to any one of (1) to (7), in which the nanostructure is dispersed in an organic solvent, and thereafter, the nanostructure is decomposed by adding an organic silane compound to obtain the inorganic oxide nanofiber.
(9)

The method of manufacturing the inorganic oxide nanofiber according to (8), in which a surface of the inorganic oxide nanofiber is modified by an organic silane molecule derived from the organic silane compound.
(10)

The method of manufacturing the inorganic oxide nanofiber according to any one of (1) to (9), in which the nanostructure is decomposed by immersing the nanostructure in an organic solvent to obtain the inorganic oxide nanofiber.
(11)

The method of manufacturing the inorganic oxide nanofiber according to (10), in which the surfactant is adsorbed to a surface of the inorganic oxide nanofiber.
(12)

The method of manufacturing the inorganic oxide nanofiber according to any one of (1) to (11), in which silicon alkoxide is used as the metal alkoxide.
(13)

The method of manufacturing the inorganic oxide nanofiber according to any one of (1) to (12), in which the surfactant includes a quaternary ammonium salt.
(14)

A nanostructure including:
a plurality of nanofibers each including an inorganic oxide; and
   a plurality of surfactants having a hydrophilic group and a hydrophobic group, the hydrophilic group being adsorbed to a surface of each of the plurality of nanofibers by an electrostatic interaction, in which
   the nanostructure has a reverse two-dimensional hexagonal structure in which the plurality of nanofibers is periodically arranged.
(15)

The nanostructure according to (14), further including
a hydrophobic additive between the plurality of nanofibers.
(16)

The nanostructure according to (14) or (15), in which an average diameter of the plurality of nanofibers is less than or equal to 10 nm.

This application claims the benefit of Japanese Priority Patent Application JP2022-166390 filed with the Japan Patent Office on Oct. 17, 2022, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A method of manufacturing an inorganic oxide nanofiber, the method comprising:
preparing a mixture solution by dissolving water, a metal alkoxide, a catalyst, and a surfactant in an aprotic or protic polar solvent;
removing the polar solvent from the mixture solution and synthesizing a nanostructure having a reverse two-dimensional hexagonal structure; and
thereafter decomposing the nanostructure.

2. The method of manufacturing the inorganic oxide nanofiber according to claim 1, wherein an acid catalyst is used as the catalyst.

3. The method of manufacturing the inorganic oxide nanofiber according to claim 2, wherein the acid catalyst comprises any of acetic acid, hydrochloric acid, nitric acid, and sulfuric acid.

4. The method of manufacturing the inorganic oxide nanofiber according to claim 1, wherein a hydrophobic additive is further added to the mixture solution.

5. The method of manufacturing the inorganic oxide nanofiber according to claim 4, wherein used as the hydrophobic additive is at least one of an alcohol having 6 to 20 carbon atoms, an alkane having 6 to 20 carbon atoms, 1,3,5-trimethylbenzene, 1,3,5-triethylbenzene, or 1,3,5-tripropylbenzene.

6. The method of manufacturing the inorganic oxide nanofiber according to claim 1, wherein the polar solvent is removed by air-drying the mixture solution.

7. The method of manufacturing the inorganic oxide nanofiber according to claim 1, wherein the polar solvent is removed by being subjected to depressurization in a closed vessel.

8. The method of manufacturing the inorganic oxide nanofiber according to claim 1, wherein the nanostructure is dispersed in an organic solvent, and thereafter, the nanostructure is decomposed by adding an organic silane compound to obtain the inorganic oxide nanofiber.

9. The method of manufacturing the inorganic oxide nanofiber according to claim 8, wherein a surface of the inorganic oxide nanofiber is modified by an organic silane molecule derived from the organic silane compound.

10. The method of manufacturing the inorganic oxide nanofiber according to claim 1, wherein the nanostructure is decomposed by immersing the nanostructure in an organic solvent to obtain the inorganic oxide nanofiber.

11. The method of manufacturing the inorganic oxide nanofiber according to claim 10, wherein the surfactant is adsorbed to a surface of the inorganic oxide nanofiber.

12. The method of manufacturing the inorganic oxide nanofiber according to claim 1, wherein silicon alkoxide is used as the metal alkoxide.

13. The method of manufacturing the inorganic oxide nanofiber according to claim 1, wherein the surfactant comprises a quaternary ammonium salt.

14. A nanostructure comprising:
a plurality of nanofibers each including an inorganic oxide; and
a plurality of surfactants having a hydrophilic group and a hydrophobic group, the hydrophilic group being adsorbed to a surface of each of the plurality of nanofibers by an electrostatic interaction, wherein
the nanostructure has a reverse two-dimensional hexagonal structure in which the plurality of nanofibers is periodically arranged.

15. The nanostructure according to claim 14, further comprising
a hydrophobic additive between the plurality of nanofibers.

16. The nanostructure according to claim 14, wherein an average diameter of the plurality of nanofibers is less than or equal to 10 nm.
